(19) United States
(12) Patent Application Publication
(10) Pub. No.: US 2014/0202684 A1
(43) Pub. Date: Jul. 24, 2014

(54) IN-SITU ACID STIMULATION OF CARBONATE FORMATIONS WITH ACID-PRODUCING MICROORGANISMS

(71) Applicant: HALLIBURTON ENERGY SERVICES, INC., HOUSTON, TX (US)

(72) Inventors: Achala V. Danait, Pune, IN (US); Lalit Pandurang Salgaonkar, Pune, IN (US); Ramesh Uppuluri, Pune, IN (US)

(73) Assignee: HALLIBURTON ENERGY SERVICES, INC., HOUSTON, TX (US)

(21) Appl. No.: 13/748,765

(22) Filed: Jan. 24, 2013

(51) Int. Cl. E21B 43/16; C09K 8/582

(52) U.S. Cl. CPC E21B 43/16; C09K 8/582
USPC 166/246

(57) ABSTRACT

Methods of treating a subterranean formation penetrated by a wellbore of a well, wherein the subterranean formation includes carbonate. The methods can include the following steps of: (1) optionally, fracturing the subterranean formation; (2) optionally, acidizing the subterranean formation with a Bronsted-Lowry acid; (3) treating the subterranean formation with an acid-producing microorganism, a nutrient for the microorganism, and, if needed, a suitable electron acceptor for respiration by the microorganism; (4) optionally, flushing the wellbore with a wash fluid to push the microorganism deeper into the subterranean formation and wash it away from the metal tubulars of the well; (5) preferably, shutting-in the well for a required incubation period for in-situ acid generation by the microorganism; and (6) preferably, after the shut-in, flowing back fluid from the subterranean formation into the wellbore.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to methods of stimulating oil or gas production.

### BACKGROUND

To produce oil or gas, a well is drilled into a subterranean formation that is an oil or gas reservoir.

### Well Servicing and Well Fluids

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a well fluid into a well.

Well services can include various types of treatments that are commonly performed in a wellbore or subterranean formation.

For example, during completion or intervention, stimulation is a type of treatment performed to enhance or restore the productivity of oil and gas from a well. Even small improvements in fluid flow can yield dramatic production results.

Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Fracturing treatments are often applied in treatment zones having poor natural permeability. Matrix treatments are often applied in treatment zones having good natural permeability to counteract damage in the near-wellbore area.

### Acidizing

The purpose of acidizing in a well is to dissolve acid-soluble materials. For example, this can help remove residual fluid material or filtercake damage or to increase the permeability of a treatment zone. Conventionally, a treatment fluid including an aqueous acid solution is introduced into a subterranean formation to dissolve the acid-soluble materials. In this way, fluids can more easily flow from the formation into the well. In addition, an acid treatment can facilitate the flow of injected treatment fluids from the well into the formation. This procedure enhances production by increasing the effective well radius.

In acid fracturing, an acidizing fluid is pumped into a formation at a sufficient pressure to cause fracturing of the formation and to create differential (non-uniform) etching leading to higher fracture conductivity. Depending on the formation mineralogy, the acidizing fluid can etch the fracture faces, whereby flow channels are formed when the fractures close. The acidizing fluid can also enlarge the pore spaces in the fracture faces and in the formation.

In matrix acidizing, an acidizing fluid is injected from the well into the formation at a rate and pressure below the pressure sufficient to create a fracture in the formation.

Greater details, methodology, and exceptions can be found in “Production Enhancement with Acid Stimulation” 2^{nd} edition by Leonard Kalfayan (PennWell 2008), SPE 129329, SPE 123869, SPE 121464, SPE 121803, SPE 121008, IPTC 10693, and the references contained therein.

The use of the term “acidizing” herein refers to both matrix and fracturing types of acidizing treatments, and more specifically, refers to the general process of introducing an acid down hole to perform a desired function, e.g., to acidize a portion of a subterranean formation or any damage contained therein.

Conventional acidizing fluids can include one or more of a variety of acids, such as hydrochloric acid, acetic acid, formic acid, hydrofluoric acid, or any combination of such acids. In addition, many fluids used in the oil and gas industry include a water source that may incidentally contain certain amounts of acid, which may cause the fluid to be at least slightly acidic.

Acidic fluids are present in a multitude of operations in the oil and gas industry. For example, acidic fluids are often used in wells penetrating subterranean formations. Such acidic fluids may be used, for example, in stimulation operations or clean-up operations in oil and gas wells. Acidic stimulation operations may use these treatment fluids in hydraulic fracturing or matrix acidizing treatments. In operations using acidic well fluids, metal surfaces of piping, tubing, pumps, blending equipment, downhole tools, etc. may be exposed to the acidic fluid.

Problems with Using Acids in Well Fluids

Although acidizing a portion of a subterranean formation can be very beneficial in terms of permeability, conventional acidizing systems have significant drawbacks.

Even weakly acidic fluids can be problematic in that they can cause corrosion of metals. Corrosion can occur anywhere in a well production system or pipeline system, including anywhere downhole in a well or in surface lines and equipment.

The expense of repairing or replacing corrosion-damaged equipment is extremely high. The corrosion problem is exacerbated by the elevated temperatures encountered in deeper formations. The increased corrosion rate of the ferrous and other metals comprising the tubular goods and other equipment results in quantities of the acidic solution being neutralized before it ever enters the subterranean formation, which can compound the deeper penetration problem discussed above. In addition, the partial neutralization of the acid from undesired corrosion reactions can result in the production of quantities of metal ions that are highly undesirable in the subterranean formation.

To combat this potential corrosion problem in operations with acidic well fluids, corrosion inhibitors have been used to reduce corrosion to metals and metal alloys with varying degrees of success.

Another drawback of some conventional corrosion inhibitors is that certain components of these corrosion inhibitors may not be compatible with the environmental standards in some regions of the world. For example, quaternary ammonium compounds, mercaptan-based compounds, and “Mannich” condensation compounds have been used as corrosion inhibitors. However, these compounds generally are not acceptable under stricter environmental regulations, such as those applicable or that will become applicable in the North Sea region. Consequently, operators in some regions may be forced to suffer increased corrosion problems, resort to using corrosion inhibitor formulations that may be less effective, or forgo the use of certain acidic treatment fluids.

One major problem associated with conventional acidizing treatment systems is that deeper penetration into the formation is not usually achievable because, inter alia, the acid may be spent before it can deeply penetrate into the subterranean formation. The rate at which acidizing fluids react with reactive materials in the subterranean formation is a function of various factors including, but not limited to, acid concentration, temperature, fluid velocity, mass transfer, and the type of reactive material encountered. Whatever the rate of reaction of the acidic solution, the solution can be introduced into the formation only a certain distance before it becomes spent. To achieve optimal results, it is desirable to maintain the acidic solution in a reactive condition for as long a period as possible to maximize the degree of penetration so that the permeability enhancement produced by the acidic solution may be increased.

Another problem associated with acidic well fluid is that the acids or the well fluids can pose handling or safety concerns due to the reactivity of the acid. For instance, during a conventional acidizing operation, corrosive fumes may be released from the acid as it is injected down the well bore. The fumes can cause an irritation hazard to nearby personnel, and a corrosive hazard to surface equipment used to carry out the operation.

Therefore, among other needs, there is a need for fluids and methods with acids that reduce the problems of using acids.

### SUMMARY OF THE INVENTION

The purpose of this invention is to provide a method of in-situ acid stimulation of carbonate formations using acid-producing microorganisms.

According to the invention, methods of treating a subterranean formation penetrated by a wellbore of a well are provided, wherein the subterranean formation includes carbonate. The methods can include the following steps of:

(1) Optionally, fracturing the subterranean formation.

(2) Optionally, acidizing the subterranean formation with a Bronsted-Lowry acid. Preferably, the Bronsted-Lowry acid is or comprises a strong acid. Preferably, the pH of the fluid is less than 4.

(3) Introducing into the subterranean formation, an acid-producing microorganism, a nutrient for the microorganism, and, optionally, a suitable electron acceptor for respiration by the microorganism.

(4) Optionally, flushing the wellbore with a wash fluid to wash the microorganism away from the metal tubulars of the well and into the subterranean formation.

(5) Preferably, shutting-in the well for a required incubation period for the growth of the microorganism and the in-situ acid generation by the microorganism. This will lead to microbial-induced acid stimulation of the subterranean formation.

(6) Preferably, after the shut-in, flowing back a fluid from the subterranean formation into the wellbore. More preferably, the methods include the step of putting the well on production.

The steps can be performed in any practical sequence and with any practical timing.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS AND BEST MODE

### Definitions and Usages

General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

The control or controlling of a condition includes any one or more of maintaining, applying, or varying of the condition. For example, controlling the temperature of a substance can include heating, cooling, or thermally insulating the substance.

Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

In geology, rock or stone is a naturally occurring solid aggregate of minerals or mineraloids. The Earth's outer solid layer, the lithosphere, is made of rock. Three major groups of rocks are igneous, sedimentary, and metamorphic. The vast majority of reservoir rocks are sedimentary rocks, but highly fractured igneous and metamorphic rocks can sometimes be reservoirs.

Carbonate, Sandstone, and Other Rock

As used herein, a subterranean formation having greater than about 50% by weight of inorganic carbonate materials is referred to as a “carbonate formation.” For example, limestone is essentially calcium carbonate. Dolomite is essentially a combination of calcium carbonate and magnesium carbonate, wherein at least 50% of the cations are magnesium.

As used herein, a subterranean formation having greater than about 50% by weight of inorganic siliceous materials (e.g., sandstone) is referred to as a “sandstone formation.”

Clays can be found in pore spaces, as part of the rock matrix, or as grain-cementing material.

A shale formation is a subterranean formation of shale. Shale is characterized by breaks along thin laminae or parallel layering or bedding less than one centimeter in thickness, called fissility.

Permeability of Reservoirs

There are conventional and non-conventional types of reservoirs.

In a conventional reservoir, the hydrocarbons flow to the wellbore in a manner that can be characterized by flow through permeable media, where the permeability may or may not have been altered near the wellbore, or flow through permeable media to a permeable (conductive), bi-wing fracture placed in the formation. A conventional reservoir would typically have a permeability greater than about 1 milliDarcy (equivalent to about 1,000 microDarcy).

In a non-conventional reservoir, the permeability is less than 1 milliDarcy. Non-conventional reservoirs include tight gas and shale.

Tight gas is natural gas that is difficult to access because the permeability is relatively low. Generally, tight gas is in a subterranean formation having a permeability in the range of about 1 milliDarcy (equivalent to about 1,000 microDarcy) to about 0.01 milliDarcy (equivalent to about 10 microDarcy).

As used herein, an ultra-low permeable formation has a permeability of less than about 1 microDarcy.

Well Terms

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, the word “tubular” means any kind of body in the general form of a tube. Examples of tubulars include, but are not limited to, a drill pipe, a casing, a tubing string, a line pipe, and a transportation pipe. Tubulars can also be used to transport fluids such as oil, gas, water, liquefied methane, coolants, and heated fluids into or out of a subterranean formation.

As used herein, a “well fluid” broadly refers to any fluid adapted to be introduced into a well for any purpose. A well fluid can be, for example, a drilling fluid, a setting composition, a treatment fluid, or a spacer fluid. If a well fluid is to be used in a relatively small volume, for example less than about 200 barrels (about 8,400 US gallons or about 32 m³), it is sometimes referred to as a wash, dump, slug, or pill.

As used herein, introducing “into a well” means introducing at least into and through the wellhead. According to various techniques known in the art, tubulars, equipment, tools, or well fluids can be directed from the wellhead into any desired portion of the wellbore.

As used herein, the word “treatment” refers to any treatment for changing a condition of a portion of a wellbore or a subterranean formation adjacent a wellbore; however, the word “treatment” does not necessarily imply any particular treatment purpose. A treatment usually involves introducing a well fluid for the treatment, in which case it may be referred to as a treatment fluid, into a well.

As used herein, a “treatment fluid” is a fluid used in a treatment. The word “treatment” in the term “treatment fluid” does not necessarily imply any particular treatment or action by the fluid.

As used herein, the terms spacer fluid, wash fluid, and inverter fluid can be used interchangeably. A spacer fluid is a fluid used to physically separate one special-purpose fluid from another. It may be undesirable for one special-purpose fluid to mix with another used in the well, so a spacer fluid compatible with each is used between the two. A spacer fluid is usually used when changing between well fluids used in a well.

A “portion” of a well refers to any downhole portion of the well.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

As used herein, a “downhole fluid” is an in-situ fluid in a well, which may be the same as a well fluid at the time it is introduced, or a well fluid mixed with another other fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the well fluid on the BHST during treatment. The design temperature for a well fluid is sometimes referred to as the bottom hole circulation temperature (“BHCT”). Because well fluids may be considerably cooler than BHST, the difference between the two temperatures can be quite large. Ultimately, if left undisturbed, a subterranean formation will return to the BHST.

Production Stages

“Primary production,” also known as “primary recovery,” is the first stage of hydrocarbon production, in which natural reservoir energy, such as gas drive, water drive, or gravity drainage, displaces hydrocarbons from the reservoir and into the wellbore. However, it is usually soon necessary to implement an artificial lift system from the wellbore adjacent the production zone to the wellhead, such as a rod pump, an electrical submersible pump or a gas-lift installation. Production to the wellhead by natural reservoir energy or using artificial lift is considered primary recovery. The primary recovery stage reaches its limit either when the reservoir pressure is so low that the production rates are not economical, or when the proportions of gas or water in the production stream are too high. During primary recovery, only a small percentage of the initial hydrocarbons in place are produced, typically around 10% for oil reservoirs.

“Secondary production,” also known as “secondary recovery,” is the second stage of hydrocarbon production. It requires reservoir injection, such as water flooding techniques, to displace hydrocarbons from the reservoir and into the wellbore.

“Tertiary production,” also known as “tertiary recovery,” is the third stage of hydrocarbon production. The principal tertiary recovery techniques are thermal methods, gas injection, and chemical flooding.

The term “enhanced oil recovery” (“EOR”) is an oil recovery enhancement method using sophisticated techniques that alter the original properties of oil. Once ranked as a third stage of oil recovery, the techniques employed during enhanced oil recovery can actually be initiated at any time during the productive life of an oil reservoir. Its purpose is not only to restore formation pressure, but also to improve oil displacement or fluid flow in the reservoir. The three major types of enhanced oil recovery operations are chemical flooding (alkaline flooding or micellar-polymer flooding), miscible displacement (carbon dioxide [CO₂] injection or hydrocarbon injection), and thermal recovery (steam flood or in-situ combustion). The optimal application of each type depends on reservoir temperature, pressure, depth, net pay, permeability, residual oil and water saturations, porosity and fluid properties such as oil API gravity and viscosity. It is typically applied to heavy oil having an API gravity of less than 22.3 degrees.

Substances, Chemicals, and Derivatives

A substance can be a pure chemical or a mixture of two or more different chemicals.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

Physical States and Phases

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand.

A particulate can be of solid or liquid particles. As used herein, however, unless the context otherwise requires, particulate refers to a solid particulate.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified in different ways, including, for example, based on the size of the dispersed particles, the uniformity or lack of uniformity of the dispersion, and, if a fluid, by whether or not precipitation occurs.

A dispersion is considered to be heterogeneous if the dispersed particles are not dissolved and are greater than about 1 nanometer in size. (For reference, the diameter of a molecule of toluene is about 1 nm and a molecule of water is about 0.3 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Heterogeneous dispersions can be further classified based on the dispersed particle size.

A heterogeneous dispersion is a “suspension” where the dispersed particles are larger than about 50 micrometers. Such particles can be seen with a microscope, or if larger than about 50 micrometers (0.05 mm), with the unaided human eye. The dispersed particles of a suspension in a liquid external phase may eventually separate on standing, e.g., settle in cases where the particles have a higher density than the liquid phase. Suspensions having a liquid external phase are essentially unstable from a thermodynamic point of view; however, they can be kinetically stable over a long period depending on temperature and other conditions.

A heterogeneous dispersion is a “colloid” where the dispersed particles range up to about 50 micrometer (50,000 nanometers) in size. The dispersed particles of a colloid are so small that they settle extremely slowly, if ever. In some cases, a colloid can be considered as a homogeneous mixture. This is because the distinction between “dissolved” and “particulate” matter can be sometimes a matter of theoretical approach, which affects whether or not it is considered homogeneous or heterogeneous.

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

Hydratability or Solubility

A substance is considered to be “soluble” in a liquid if at least 10 gram of the substance can be dissolved in one liter of the liquid when tested at 77° F. and 1 atmosphere pressure for 2 hours, considered to be “insoluble” if less than 1 gram per liter, and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to intermolecular forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of intermolecular forces.)

Every fluid inherently has at least a continuous phase. A fluid can have more than one phase. The continuous phase of a well fluid is a liquid under Standard Laboratory Conditions. For example, a well fluid can be in the form of a suspension (larger solid particles dispersed in a liquid phase), a sol (smaller solid particles dispersed in a liquid phase), an emulsion (liquid particles dispersed in another liquid phase), or a foam (a gas phase dispersed in a liquid phase).

As used herein, a water-based fluid means that water or an aqueous solution is the dominant material of the continuous phase, that is, greater than 50% by weight, of the continuous phase of the fluid based on the combined weight of water and any other solvents in the phase (that is, excluding the weight of any dissolved solids).

In contrast, “oil-based” means that oil is the dominant material by weight of the continuous phase of the fluid. In this context, the oil of an oil-based fluid can be any oil.

In the context of a well fluid, “oil” is understood to refer to an oil liquid, whereas gas is understood to refer to a physical state of a substance, in contrast to a liquid. In this context, “oil” is any substance that is liquid under Standard Laboratory Conditions, is hydrophobic, and soluble in organic solvents. Oils have a high carbon and hydrogen content and are non-polar substances. This general definition includes classes such as petrochemical oils, vegetable oils, and many organic solvents. All oils can be traced back to organic sources.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (i.e., shear rate) than simple linearity. Thus, there exist a number of forms of non-Newtonian fluids. Shear thickening fluids have an apparent viscosity that increases with increasing the rate of shear. Shear thinning fluids have a viscosity that decreases with increasing rate of shear. Thixotropic fluids become less viscous over time at a constant shear rate. Rheopectic fluids become more viscous over time at a constant shear rate. A Bingham plastic is a material that behaves as a solid at low stresses but flows as a viscous fluid at high yield stresses.

Most well fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of centipoise (“cP”).

Like other physical properties, the viscosity of a Newtonian fluid or the apparent viscosity of a non-Newtonian fluid may be highly dependent on the physical conditions, primarily temperature and pressure.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel. A “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

As used herein, a substance referred to as a “gel” is subsumed by the concept of “fluid” if it is a pumpable fluid.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette device, such as a FANN™ Model 35 or 50 viscometer or a CHANDLER™ 5550 HPHT viscometer, that measures viscosity as a function of time, temperature, and shear rate. The viscosity-measuring instrument can be calibrated using standard viscosity silicone oils or other standard viscosity fluids.

Due to the geometry of most common viscosity-measuring devices, however, solid particulate, especially if larger than silt (larger than 74 micrometer), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

Unless otherwise specified, the apparent viscosity of a fluid (excluding any suspended solid particulate larger than silt) is measured with a FANN™ Model 35 type viscometer using an R1 rotor, B1 bob, and F1 torsion spring at a shear rate of 511 l/s, and at a temperature of 77° F. (25° C.) and a pressure of 1 atmosphere.

A substance is considered to be a fluid if it has an apparent viscosity less than 5,000 cP (independent of any gel characteristic). For reference, the viscosity of pure water is about 1 cP.

As used herein, for the purposes of matrix diversion in an acidizing treatment, the viscosity of a spent acidizing fluid should be higher than the reservoir crude present in the formation rock. The properties of the crude, including viscosity, can vary from location to location and from reservoir to reservoir. In addition, the viscosity of oil decreases with increasing temperature, for example, in a formation with a higher bottom hole temperature (BHT) the viscosity of the crude will be lower. As a rule of thumb, the average viscosity of crude oil is considered to be 50 mPa·s (50 cP) at 40 l/s. In general, viscosity of a spent acid fluid above 50 mPa·s (50 cP) at 40 l/s is considered as the accepted value at the design temperature. The higher viscosity of the spent acid fluid is always desirable.

Permeability

Permeability refers to how easily fluids can flow through a material. For example, if the permeability is high, then fluids will flow more easily and more quickly through the material. If the permeability is low, then fluids will flow less easily and more slowly through the material. As used herein, unless otherwise specified, permeability is measured with a light oil having an API gravity of greater than 31.1 degrees.

As used herein, “high permeability” means the material has a permeability of at least 100 millidarcy (mD). As used herein, “low permeability” means the material has a permeability of less than 1 mD.

Corrosion and Inhibitors

Corrosion of metals can occur anywhere in an oil or gas production system, such in the downhole tubulars, equipment, and tools of a well, in surface lines and equipment, or transportation pipelines and equipment.

“Corrosion” is the loss of metal due to chemical or electrochemical reactions, which could eventually destroy a structure. The corrosion rate will vary with time depending on the particular conditions to which a metal is exposed, such as the amount of water, pH, other chemicals, temperature, and pressure. Examples of common types of corrosion include, but are not limited to, the rusting of metal, the dissolution of a metal in an acidic solution, oxidation of a metal, chemical attack of a metal, electrochemical attack of a metal, and patina development on the surface of a metal.

Even weakly acidic fluids having a pH between 4 to 6 can be problematic in that they can cause corrosion of metals. As used herein with reference to the problem of corrosion, “acid” or “acidity” refers to a Bronsted-Lowry acid or acidity.

As used herein, the term “inhibit” or “inhibitor” refers to slowing down or lessening the tendency of a phenomenon (e.g., corrosion) to occur or the degree to which that phenomenon occurs. The term “inhibit” or “inhibitor” does not imply any particular mechanism, or degree of inhibition.

A “corrosion inhibitor package” can include one or more different chemical corrosion inhibitors, sometimes delivered to the well site in one or more solvents to improve flowability or handleability of the corrosion inhibitor before forming a well fluid.

When included, a corrosion inhibitor is preferably in a concentration of at least 0.1% by weight of a fluid. More preferably, the corrosion inhibitor is in a concentration in the range of 0.1% to 15% by weight of the fluid.

An example of a corrosion inhibitor package contains an aldehyde (i.e., cinnamaldehyde), methanol, isopropanol, and a quaternary ammonium salt (e.g., 1-(benzyl)quinolinium chloride).

A corrosion inhibitor “intensifier” is a chemical compound that itself does not inhibit corrosion, but enhances the effectiveness of a corrosion inhibitor over the effectiveness of the corrosion inhibitor without the corrosion inhibitor intensifier. A corrosion inhibitor intensifier can be selected from the group consisting of: formic acid, potassium iodide, and any combination thereof.

When included, a corrosion inhibitor intensifier is preferably in a concentration of at least 0.1% by weight of the fluid. More preferably, the corrosion inhibitor intensifier is in a concentration in the range of 0.1% to 20% by weight of the fluid.

General Measurement Terms

Unless otherwise specified or unless the context otherwise clearly requires, any ratio or percentage means by weight.

Unless otherwise specified or unless the context otherwise clearly requires, the phrase “by weight of the water” means the weight of the water of an aqueous phase of the fluid without the weight of any viscosity-increasing agent, dissolved salt, suspended particulate, or other materials or additives that may be present in the water.

If there is any difference between U.S. or Imperial units, U.S. units are intended. For example, “GPT” or “gal/Mgal” means U.S. gallons per thousand U.S. gallons and “ppt” means pounds per thousand U.S. gallons.

The barrel is the unit of measure used in the US oil industry, wherein one barrel equals 42 U.S. gallons. Standards bodies such as the American Petroleum Institute (API) have adopted the convention that if oil is measured in oil barrels, it will be at 14.696 psi and 60° F., whereas if it is measured in cubic meters, it will be at 101.325 kPa and 15° C. (or in some cases 20° C.). The pressures are the same but the temperatures are different—60° F. is 15.56° C., 15° C. is 59° F., and 20° C. is 68° F. However, if all that is needed is to convert a volume in barrels to a volume in cubic meters without compensating for temperature differences, then 1 bbl equals 0.159 m³ or 42 U.S. gallons.

Unless otherwise specified, mesh sizes are in U.S. Standard Mesh.

Converted to SI units, 1 darcy is equivalent to 9.869233×10⁻¹³ m² or 0.9869233 (μm)². This conversion is usually approximated as 1 (μm)².

Oil gravity represents the density of the oil at stock tank conditions. The oil gravity has a very strong effect on the calculated oil viscosity (mₒ) and solution gas oil ratio (Rₛ). It has an indirect effect on the oil compressibility (cₒ) and the oil formation volume factor (Bₒ), since these variables are affected by the solution gas-oil ratio (Rₛ), which is a function of oil gravity. Usually the oil gravity is readily known or determined. It ranges from 45° API to 10° API. The conversion from API gravity (oil field units) to density (kg/m³ (SI units)) is: 141.5/[° API gravity+131.5]. Oil is classified as heavy oil if it has an API gravity of less than 22.3° API, medium oil if it has an API gravity from 22.3 to 31.1° API, and light oil if it has an API gravity greater than 31.1° API. If unknown, the default value used is for a medium oil of 30° API.

General Objectives

Strongly acidic solutions tend to be more corrosive to metals. In addition, strongly acidic solutions may react too quickly with the carbonate of a subterranean formation, resulting in undesired wormholing and other undesirable effects. Moreover, handling of even weak acids in concentrated solutions can present environmental concerns. Due to stricter environmental regulations, the use of large quantities of acids will become difficult in future.

According to the invention, stimulation of carbonate formations is achieved by introducing an acid-producing microorganism into the formation, preferably after a step of fracturing. The acid-producing microorganism releases one or more weak acids, which can react with the carbonate to generate channels resulting in enhanced permeability within the carbonate reservoir. However, because the acid is generated slowly, the treatment fluid can be pushed into the formation before acid is generated.

Limestone is a sedimentary rock, comprising of calcium carbonate, which forms in warm, shallow marine waters. The rock can form as a result of the accumulation of shell, coral, algal, or fecal debris, as well as calcium carbonate precipitation from lake and ocean waters.

Over time, the permeable and soluble limestone can be eroded by the action of water. For example, the weak carbonic acid from rainwater can react with the limestone rock, dissolve it, and erode it away. The dissolution and erosion of the limestone gives rise to what we call, “limestone caves.” In the oilfield industry, the commonly referred term “carbonate formations” are essentially limestone or dolomite formations that have not been eroded away by action of water.

Geochemical rates of mineral dissolution and deposition are dependent on groundwater acidity and CO₂ partial pressures. Mineral dissolution can also result from the action of very acidic sediment fluids that are under saturated with carbonate minerals. The source of the acids and elevated CO₂ pressures is attributable to the action of microbial metabolism in biofilms associated with limestone surfaces and interclastic spaces between particles of sediment.

Experiments conducted by Fowler et al demonstrate the dissolution of calcite (Iceland spar) by bacteria isolated from the cave sediments. Many bacteria, especially members of the family Enterobacteriaceae, carry out mixed acid fermentation, which results in the excretion of complex mixture of acids and the production of carbon dioxide. Calcite dissolution kinetics were presumed to be limited by diffusional transport through the mineral/fluid surface boundary layer.

There has been evidence to support the presence and growth of bacteria at reservoir temperatures and pressures, such as extremophiles, including thermophiles and barophiles.

While microbial techniques have been used in EOR, it has never been recognized that the techniques could be applied to acidizing of carbonate formations in non-EOR applications.

The present invention discloses a novel approach to stimulate limestone formations using acid producing microorganisms, based on the evidences of limestone dissolution occurring in limestone caves. By injecting an acid-producing microorganism, stimulation can be initiated in a subterranean formation. The release of acidic mixtures by the microorganism colonies can generate channels resulting in enhanced permeability within the carbonate reservoir.

A process according to the methods of the invention will ensure that the acid released by the microorganism is spent on the carbonate formation and are not available for attack on metal tubulars. This will hence prevent microbial induced corrosion (“MIC”) of wellbore tubulars, which has recently gained attention and concern.

The preparation of bacteria-nutrient mixtures is a well-established commercial process utilizing low cost raw materials, and is widely used in many industry segments for various purposes. Hence, the present invention can be a cost effective and commercially viable technology.

According to the invention, methods of treating a subterranean formation penetrated by a wellbore of a well are provided, wherein the subterranean formation includes carbonate. The methods can include the following steps of:

(1) Optionally, fracturing the subterranean formation.

(2) Optionally, acidizing the subterranean formation with a Bronsted-Lowry acid. Preferably, the Bronsted-Lowry acid is or comprises a strong acid. Preferably, the pH of the fluid is less than 4.

(3) Introducing into the subterranean formation, an acid-producing microorganism, a nutrient for the microorganism, and, optionally, a suitable electron acceptor for respiration by the microorganism.

(4) Optionally, flushing the wellbore with a wash fluid to wash the microorganism away from the metal tubulars of the well and into the subterranean formation.

(5) Preferably, shutting-in the well for a required incubation period for the growth of the microorganism and the in-situ acid generation by the microorganism. This will lead to microbial-induced acid stimulation of the subterranean formation.

(6) Preferably, after the shut-in, flowing back fluid from the subterranean formation into the wellbore. More preferably, the methods include the step of putting the well on production.

The steps can be performed in any practical sequence and with any practical timing.

It should be understood, of course, that after shutting in, any of the fracturing fluid, the acidizing fluid, or the treatment fluid with the microorganism that was previously introduced into the formation would be expected to be intermixed or changed in composition from the time of introducing into the formation. This would result in a downhole fluid different from what was originally introduced. For example, a fracturing fluid, if viscosified, may include a breaker for breaking the viscosity of the fluid. An acidizing fluid including an acid would be expected to spend the acid against the carbonate in the formation. And a treatment fluid including the microorganism and nutrition would be expected to generate acid, spend the acid against the carbonate, and otherwise change composition.

Preferably, the step of introducing the microorganism is prior to a step of flowing back from the subterranean formation any downhole fluid resulting from the fracturing fluid. In another preferred sub-combination, the step of fracturing and the step of introducing the microorganism are performed without tripping out a work string, which is the tubing string used to convey a treatment fluid into a well for well service operations. In yet another preferred sub-combination of the steps, the step of introducing the microorganism is within 3 months of the step of fracturing.

It should also be understood that the step from introducing the microorganism through the step of shutting in should avoid introducing into the subterranean formation any biocidal concentration of any biocide to the microorganism.

It should be understood that these steps can optionally be separate or combined as practical. For example, the step of fracturing can be simultaneous with, overlap with, or be combined with the step of acidizing. By way of another example, any of the steps of fracturing, acidizing, and treating with the microorganism can be simultaneous with, overlap with, or combined with each other. For example, any two or all three of the fracturing fluid, the acidizing fluid, and the treatment fluid with the microorganism can be combined and introduced into the well simultaneously for the different purposes of the steps, under the same or different conditions.

By way of yet another example, the step of treating the formation with the microorganism can be performed with a fluid including the nutrition, or the nutrition can be introduced separately. Preferably, the microorganism and the nutrition are introduced together in the same treatment fluid.

It should also be understood that the steps can be performed in any practical sequence. For example, if included in the method, the step of fracturing can be performed before or after the step of introducing the microorganism. Preferably, the step of fracturing is performed before the step of introducing the microorganism, wherein the microorganism is introduced into a fracture in the formation created by the step of fracturing. Similarly, if included in the method, the step of acidizing with an acid can be performed in any practical sequence with the other steps. Preferably, the step of acidizing with an acid is performed before the step of introducing the microorganism for in-situ acid generation.

These and other possible sub-combinations according to the invention will be understood and appreciated by those of skill in the art with the benefit of the disclosure of the inventive concepts.

Optional Step of Hydraulic Fracturing

Hydraulic fracturing is a stimulation treatment. The purpose of a hydraulic fracturing treatment is to provide an improved flow path for oil or gas to flow from the hydrocarbon-bearing formation to the wellbore. In addition, a fracturing treatment can facilitate the flow of injected treatment fluids from the well into the formation. A treatment fluid adapted for this purpose is sometimes referred to as a fracturing fluid. The fracturing fluid is pumped at a sufficiently high flow rate and pressure into the wellbore and into the subterranean formation to create or enhance one or more fractures in the subterranean formation. Creating a fracture means making a new fracture in the formation Enhancing a fracture means enlarging a pre-existing fracture in the formation.

A frac pump is used for hydraulic fracturing. A frac pump is a high-pressure, high-volume pump. Typically, a frac pump is a positive-displacement reciprocating pump. The fracturing fluid can be pumped down into the wellbore at high rates and pressures, for example, at a flow rate in excess of 50 barrels per minute (“bpm”) (2,100 U.S. gallons per minute) at a pressure in excess of 5,000 pounds per square inch (“psi”). The pump rate and pressure of the fracturing fluid may be even higher, for example, flow rates in excess of 100 barrels per minute and pressures in excess of 10,000 psi are often encountered.

Fracturing a subterranean formation often uses hundreds of thousands of gallons of fracturing fluid or more. Further, it is often desirable to fracture more than one treatment zone of a well. Thus, a high volume of fracturing fluids is often used in fracturing of a well, which means that a low-cost fracturing fluid is desirable. Because of the ready availability and relative low cost of water compared to other liquids, among other considerations, a fracturing fluid is usually water-based.

The formation or extension of a fracture in hydraulic fracturing may initially occur suddenly. When this happens, the fracturing fluid suddenly has a fluid flow path through the fracture to flow more rapidly away from the wellbore. As soon as the fracture is created or enhanced, the sudden increase in the flow of fluid away from the well reduces the pressure in the well. Thus, the creation or enhancement of a fracture in the formation may be indicated by a sudden drop in fluid pressure, which can be observed at the wellhead. After initially breaking down the formation, the fracture may then propagate more slowly, at the same pressure or with little pressure increase. It can also be detected with seismic techniques.

Proppant for Hydraulic Fracturing

A newly-created or newly-extended fracture will tend to close together after the pumping of the fracturing fluid is stopped. To prevent the fracture from closing, a material is usually placed in the fracture to keep the fracture propped open and to provide higher fluid conductivity than the matrix of the formation. A material used for this purpose is referred to as a proppant.

A proppant is in the form of a solid particulate, which can be suspended in the fracturing fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the wellbore compared to the permeability of the matrix of the surrounding subterranean formation. This higher-permeability flow path increases oil and gas production from the subterranean formation.

A particulate for use as a proppant is usually selected based on the characteristics of size range, crush strength, and solid stability in the types of fluids that are encountered or used in wells. Preferably, a proppant should not melt, dissolve, or otherwise degrade from the solid state under the downhole conditions.

The proppant is selected to be an appropriate size to prop open the fracture and bridge the fracture width expected to be created by the fracturing conditions and the fracturing fluid. If the proppant is too large, it will not easily pass into a fracture and will screenout too early. If the proppant is too small, it will not provide the fluid conductivity to enhance production. See, for example, W. J. McGuire and V. J. Sikora, “The Effect of Vertical Fractures on Well Productivity,” Trans., AIME (1960) 219, 401-403. In the case of fracturing relatively permeable or even tight-gas reservoirs, a proppant pack should provide higher permeability than the matrix of the formation. In the case of fracturing ultra-low permeable formations, a proppant pack should provide for higher permeability than the naturally occurring fractures or other micro-fractures of the fracture complexity.

Appropriate sizes of particulate for use as a proppant are typically in the range from about 8 to about 100 U.S. Standard Mesh. A typical proppant is sand-sized, which geologically is defined as having a largest dimension ranging from about 0.06 millimeters up to about 2 millimeters (mm). (The next smaller particle size class below sand size is silt, which is defined as having a largest dimension ranging from less than about 0.06 mm down to about 0.004 mm.) As used herein, proppant does not mean or refer to suspended solids, silt, fines, or other types of insoluble solid particulate smaller than about 0.06 mm (about 230 U.S. Standard Mesh). Further, it does not mean or refer to particulates larger than about 3 mm (about 7 U.S. Standard Mesh).

The proppant is sufficiently strong, that is, has a sufficient compressive or crush resistance, to prop the fracture open without being deformed or crushed by the closure stress of the fracture in the subterranean formation. For example, for a proppant material that crushes under closure stress, a 20/40 mesh proppant preferably has an API crush strength of at least 4,000 psi closure stress based on 10% crush fines according to procedure API RP-56. A 12/20 mesh proppant material preferably has an API crush strength of at least 4,000 psi closure stress based on 16% crush fines according to procedure API RP-56. This performance is that of a medium crush-strength proppant, whereas a very high crush-strength proppant would have a crush-strength of about 10,000 psi. In comparison, for example, a 100-mesh proppant material for use in an ultra-low permeable formation preferably has an API crush strength of at least 5,000 psi closure stress based on 6% crush fines. The higher the closing pressure of the formation of the fracturing application, the higher the strength of proppant is needed. The closure stress depends on a number of factors known in the art, including the depth of the formation.

Further, a suitable proppant should be stable over time and not dissolve in fluids commonly encountered in a well environment. Preferably, a proppant material is selected that will not dissolve in water or crude oil.

Suitable proppant materials include, but are not limited to, sand (silica), ground nut shells or fruit pits, sintered bauxite, glass, plastics, ceramic materials, processed wood, resin coated sand or ground nut shells or fruit pits or other composites, and any combination of the foregoing. Mixtures of different kinds or sizes of proppant can be used as well. In conventional reservoirs, if sand is used, it commonly has a median size anywhere within the range of about 20 to about 100 U.S. Standard Mesh. For a synthetic proppant, it commonly has a median size anywhere within the range of about 8 to about 100 U.S. Standard Mesh.

The concentration of proppant in the treatment fluid depends on the nature of the subterranean formation. As the nature of subterranean formations differs widely, the concentration of proppant in the treatment fluid may be in the range of from about 0.03 kilograms to about 12 kilograms of proppant per liter of liquid phase (from about 0.1 lb/gal to about 25 lb/gal).

Coated Proppant for Hydraulic Fracturing

One common problem is that the proppant may not be sufficiently strong by itself to prop open a fracture. Another common problem is that the surface of the proppant may have an undesirable wettability characteristic for producing oil or gas from a particular subterranean formation. Another common problem is that, as the oil or gas moves through the subterranean formation, it can dislodge and carry particulate with the fluid into the wellbore. The migration of this particulate can plug pores in the formation or proppant pack, decreasing production, in addition to causing abrasive damage to wellbore pumps, tubing, and other equipment.

To help alleviate some of the common problems mentioned above, a resinous material can be coated on the proppant. The term “coated” does not imply any particular degree of coverage on the proppant particulates, which coverage can be partial or complete.

As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

For example, some or all of the proppant can be coated with a curable resin. The curable resin can be allowed to cure on the proppant prior to the proppant being introduced into the well. The cured resin coating on the proppant provides a protective shell encapsulating the proppant and keeping the fine particulates in place if the proppant was crushed or provides a different wettable surface than the proppant without the coating.

A curable resin coating on the proppant can be allowed to cure after the proppant is placed in the subterranean formation for the purpose of consolidating the proppant of a proppant pack to form a “proppant matrix.” As used herein, “proppant matrix” means a closely associated group of proppant particles as a coherent mass of proppant. Typically, a cured resin consolidates the proppant pack into a hardened, permeable, coherent mass. After curing, the resin reinforces the strength of the proppant pack and reduces the flow back of proppant from the proppant pack relative to a similar proppant pack without such a cured resin coating.

A resin or curable resin can be selected from natural resins, synthetic resins, and any combination thereof in any proportion. Natural resins include, but are not limited to, shellac. Synthetic resins include, but are not limited to, epoxies, furans, phenolics, and furfuryl alcohols, and any combination thereof in any proportion. Examples of resins suitable for coating particulates are described in U.S. Pat. Nos. 6,668,926; 6,729,404; and 6,962,200. An example of a suitable commercially available resin is the “EXPEDITE” product sold by Halliburton Energy Services, Inc. of Duncan, Okla.

By way of another example, some or all of the proppant can be coated with a tackifying agent, instead of, or in addition to, a curable resin. The tackifying agent acts to consolidate and help hold together the proppant of a proppant pack to form a proppant matrix. Such a proppant matrix can be flexible rather than hard. The tackifying-agent-coated proppant in the subterranean formation tends to cause small particulates, such as fines, to stick to the outside of the proppant. This helps prevent the fines from flowing with a fluid, which could potentially clog the openings to pores.

Tackifying agents include, but are not limited to, polyamides, polyesters, polyethers and polycarbamates, polycarbonates, and any combination thereof in any proportion. Examples of tackifying agents suitable for coating particulates are described in U.S. Pat. Nos. 5,853,048; 5,833,000; 5,582,249; 5,775,425; 5,787,986, 7,131,491 the relevant disclosures of which are herein incorporated by reference. An example of a suitable commercially available tackifying agent is the “SANDWEDGE” product sold by Halliburton Energy Services, Inc. of Duncan, Okla.

Carrier Fluid for Particulate

A well fluid can be adapted to be a carrier fluid for particulates.

For example, a proppant used in fracturing may have a much different density than the carrier fluid. For example, sand has a specific gravity of about 2.7, whereas water has a specific gravity of 1.0 at Standard Laboratory Conditions of temperature and pressure. A proppant having a different density than water will tend to separate from water very rapidly.

As many well fluids are water-based, partly for the purpose of helping to suspend particulate of higher density, and for other reasons known in the art, the density of the fluid used in a well can be increased by including highly water-soluble salts in the water, such as potassium chloride. However, increasing the density of a well fluid will rarely be sufficient to match the density of the particulate.

Increasing Viscosity of Fluid for Suspending Particulate

Increasing the viscosity of a well fluid can help prevent a particulate having a different specific gravity than a surrounding phase of the fluid from quickly separating out of the fluid.

A viscosity-increasing agent can be used to increase the ability of a fluid to suspend and carry a particulate material in a well fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

In general, because of the high volume of fracturing fluid typically used in a fracturing operation, it is desirable to efficiently increase the viscosity of fracturing fluids to the desired viscosity using as little viscosity-increasing agent as possible. In addition, relatively inexpensive materials are preferred. Being able to use only a small concentration of the viscosity-increasing agent requires a lesser amount of the viscosity-increasing agent in order to achieve the desired fluid viscosity in a large volume of fracturing fluid.

Polymers for Increasing Viscosity

Certain kinds of polymers can be used to increase the viscosity of a fluid. In general, the purpose of using a polymer is to increase the ability of the fluid to suspend and carry a particulate material. Polymers for increasing the viscosity of a fluid are preferably soluble in the external phase of a fluid. Polymers for increasing the viscosity of a fluid can be naturally occurring polymers such as polysaccharides, derivatives of naturally occurring polymers, or synthetic polymers.

Well fluids used in high volumes, such as fracturing fluids, are usually water-based. Efficient and inexpensive viscosity-increasing agents for water include certain classes of water-soluble polymers.

As will be appreciated by a person of skill in the art, the dispersibility or solubility in water of a certain kind of polymeric material may be dependent on the salinity or pH of the water. Accordingly, the salinity or pH of the water can be modified to facilitate the dispersibility or solubility of the water-soluble polymer. In some cases, the water-soluble polymer can be mixed with a surfactant to facilitate its dispersibility or solubility in the water or salt solution utilized.

The water-soluble polymer can have an average molecular weight in the range of from about 50,000 to 20,000,000, most preferably from about 100,000 to about 4,000,000. For example, guar polymer is believed to have a molecular weight in the range of about 2 to about 4 million.

Typical water-soluble polymers used in well treatments include water-soluble polysaccharides and water-soluble synthetic polymers (e.g., polyacrylamide). The most common water-soluble polysaccharides employed in well treatments are guar and its derivatives.

As used herein, a “polysaccharide” can broadly include a modified or derivative polysaccharide.

A polymer can be classified as being single chain or multi chain, based on its solution structure in aqueous liquid media. Examples of single-chain polysaccharides that are commonly used in the oilfield industry include guar, guar derivatives, and cellulose derivatives. Guar polymer, which is derived from the beans of a guar plant, is referred to chemically as a galactomannan gum. Examples of multi-chain polysaccharides include xanthan, diutan, and scleroglucan, and derivatives of any of these. Without being limited by any theory, it is currently believed that the multi-chain polysaccharides have a solution structure similar to a helix or are otherwise intertwined.

The viscosity-increasing agent can be provided in any form that is suitable for the particular well fluid or application. For example, the viscosity-increasing agent can be provided as a liquid, gel, suspension, or solid additive that incorporated into a well fluid.

If used, a viscosity-increasing agent may be present in the well fluids in a concentration in the range of from about 0.01% to about 5% by weight of the continuous phase therein.

Crosslinking of Polymer to Increase Viscosity of a Fluid or Form a Gel

The viscosity of a fluid at a given concentration of viscosity-increasing agent can be greatly increased by crosslinking the viscosity-increasing agent. A crosslinking agent, sometimes referred to as a crosslinker, can be used for this purpose. A crosslinker interacts with at least two polymer molecules to form a “crosslink” between them.

If crosslinked to a sufficient extent, the polysaccharide may form a gel with water. Gel formation is based on a number of factors including the particular polymer and concentration thereof, the particular crosslinker and concentration thereof, the degree of crosslinking, temperature, and a variety of other factors known to those of ordinary skill in the art.

For example, one of the most common viscosity-increasing agents used in the oil and gas industry is guar. A mixture of guar dissolved in water forms a base gel, and a suitable crosslinking agent can be added to form a much more viscous fluid, which is then called a crosslinked fluid. The viscosity of base gels of guar is typically about 20 to about 50 cp. When a base gel is crosslinked, the viscosity is increased by 2 to 100 times depending on the temperature, the type of viscosity testing equipment and method, and the type of crosslinker used.

The degree of crosslinking depends on the type of viscosity-increasing polymer used, the type of crosslinker, concentrations, temperature of the fluid, etc. Shear is usually required to mix the base gel and the crosslinking agent. Thus, the actual number of crosslinks that are possible and that actually form also depends on the shear level of the system. The exact number of crosslink sites is not well known, but it could be as few as one to about ten per polymer molecule. The number of crosslinks is believed to significantly alter fluid viscosity.

For a polymeric viscosity-increasing agent, any crosslinking agent that is suitable for crosslinking the chosen monomers or polymers may be used.

Cross-linking agents typically comprise at least one metal ion that is capable of cross-linking the viscosity-increasing agent molecules.

Some crosslinking agents form substantially permanent crosslinks with viscosity-increasing polymer molecules. Such crosslinking agents include, for example, crosslinking agents of at least one metal ion that is capable of crosslinking gelling agent polymer molecules. Examples of such crosslinking agents include, but are not limited to, zirconium compounds (such as, for example, zirconium lactate, zirconium lactate triethanolamine, zirconium carbonate, zirconium acetylacetonate, zirconium maleate, zirconium citrate, zirconium oxychloride, and zirconium diisopropylamine lactate); titanium compounds (such as, for example, titanium lactate, titanium maleate, titanium citrate, titanium ammonium lactate, titanium triethanolamine, and titanium acetylacetonate); aluminum compounds (such as, for example, aluminum acetate, aluminum lactate, or aluminum citrate); antimony compounds; chromium compounds; iron compounds (such as, for example, iron chloride); copper compounds; zinc compounds; sodium aluminate; or a combination thereof.

Crosslinking agents can include a crosslinking agent composition that may produce delayed crosslinking of an aqueous solution of a crosslinkable organic polymer, as described in U.S. Pat. No. 4,797,216, the entire disclosure of which is incorporated herein by reference. Crosslinking agents can include a crosslinking agent composition that may include a zirconium compound having a valence of +4, an alpha-hydroxy acid, and an amine compound as described in U.S. Pat. No. 4,460,751, the entire disclosure of which is incorporated herein by reference.

Some crosslinking agents do not form substantially permanent crosslinks, but rather chemically labile crosslinks with viscosity-increasing polymer molecules. For example, a guar-based gelling agent that has been crosslinked with a borate-based crosslinking agent does not form permanent cross-links.

Where present, the cross-linking agent generally should be included in the fluids in an amount sufficient, among other things, to provide the desired degree of cross linking. In some embodiments, the cross-linking agent may be present in the treatment fluids in an amount in the range of from about 0.01% to about 5% by weight of the treatment fluid.

Buffering compounds may be used if desired, e.g., to delay or control the cross linking reaction. These may include glycolic acid, carbonates, bicarbonates, acetates, phosphates, and any other suitable buffering agent.

Sometimes, however, crosslinking is undesirable, as it may cause the polymeric material to be more difficult to break and it may leave an undesirable residue in the formation.

Viscosifying Surfactants (i.e. Viscoelastic Surfactants)

It should be understood that merely increasing the viscosity of a fluid may only slow the settling or separation of distinct phases and does not necessarily stabilize the suspension of any particles in the fluid.

Certain viscosity-increasing agents can also help suspend a particulate material by increasing the elastic modulus of the fluid. The elastic modulus is the measure of a substance's tendency to be deformed non-permanently when a force is applied to it. The elastic modulus of a fluid, commonly referred to as G′, is a mathematical expression and defined as the slope of a stress versus strain curve in the elastic deformation region. G′ is expressed in units of pressure, for example, Pa (Pascal) or dyne/cm². As a point of reference, the elastic modulus of water is negligible and considered to be zero.

An example of a viscosity-increasing agent that is also capable of increasing the suspending capacity of a fluid is to use a viscoelastic surfactant. As used herein, the term “viscoelastic surfactant” or “VES” refers to a surfactant that imparts or is capable of imparting viscoelastic behavior to a fluid due, at least in part, to the three-dimensional association of surfactant molecules to form viscosifying micelles. When the concentration of the viscoelastic surfactant in a viscoelastic fluid significantly exceeds a critical concentration, and in most cases in the presence of an electrolyte, surfactant molecules aggregate into species such as micelles, which can interact to form a network exhibiting elastic behavior.

As used herein, the term “micelle” is defined to include any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure.

These micelles may function, among other purposes, to stabilize emulsions, break emulsions, stabilize a foam, change the wettability of a surface, solubilize certain materials, or reduce surface tension. When used as a viscosity-increasing agent, the molecules (or ions) of the surfactants used associate to form micelles of a certain micellar structure (e.g., rodlike, wormlike, vesicles, etc., which are referred to herein as “viscosifying micelles”) that, under certain conditions (e.g., concentration, ionic strength of the fluid, etc.) are capable of, inter alia, imparting increased viscosity to a particular fluid or forming a gel. Certain viscosifying micelles may impart increased viscosity to a fluid such that the fluid exhibits viscoelastic behavior (e.g., shear thinning properties) due, at least in part, to the association of the surfactant molecules contained therein.

As used herein, the term “VES fluid” (or “surfactant gel”) refers to a fluid that exhibits or is capable of exhibiting viscoelastic behavior due, at least in part, to the association of surfactant molecules contained therein to form viscosifying micelles.

Viscoelastic surfactants may be cationic, anionic, or amphoteric in nature. The viscoelastic surfactants can include any number of different compounds, including ester sulfonates, hydrolyzed keratin, sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives thereof, and combinations thereof.

Examples of commercially-available viscoelastic surfactants include, but are not limited to, MIRATAINE BET-O 30™ (an oleamidopropyl betaine surfactant available from Rhodia Inc., Cranbury, N.J.), AROMOX APA-T™ (amine oxide surfactant available from Akzo Nobel Chemicals, Chicago, Ill.), ETHOQUAD O/12 PG™ (a fatty amine ethoxylate quat surfactant available from Akzo Nobel Chemicals, Chicago, Ill.), ETHOMEEN T/12™ (a fatty amine ethoxylate surfactant available from Akzo Nobel Chemicals, Chicago, Ill.), ETHOMEEN S/12™ (a fatty amine ethoxylate surfactant available from Akzo Nobel Chemicals, Chicago, Ill.), and REWOTERIC AM TEG™ (a tallow dihydroxyethyl betaine amphoteric surfactant available from Degussa Corp., Parsippany, N.J.). See, for example, U.S. Pat. No. 7,727,935 issued Jun. 1, 2010 having for named inventor Thomas D. Welton entitled “Dual-Function Additives for Enhancing Fluid Loss Control and Stabilizing Viscoelastic Surfactant Fluids,” which is incorporated herein by reference in the entirety.

Slick-Water Fracturing of Ultra-Low Permeable Formations

An example of a well treatment that may utilize a friction-reducing polymer is commonly referred to as “high-rate water fracturing” or “slick-water fracturing,” which is commonly used for fracturing of ultra-low permeable formations.

Ultra-low permeable formations tend to have a naturally occurring network of multiple interconnected micro-sized fractures. The fracture complexity is sometimes referred to in the art as a fracture network. Ultra-low permeable formations can be fractured to create or increase such multiple interconnected micro-sized fractures. This approach can be used to help produce gas from such an ultra-low permeable formation.

Ultra-low permeable formations are usually fractured with water-based fluids having little viscosity and that are used to suspend relatively low concentrations of proppant. The size of the proppant is sized to be appropriate for the fracture complexity of such a formation, which is much smaller than used for fracturing higher permeability formations such as sandstone or even tight gas reservoirs. The overall purpose is to increase or enhance the fracture complexity of such a formation to allow the gas to be produced. Although the fractures of the fracture network are very small compared to fractures formed in higher permeability formations, they should still be propped open.

Preferably, a friction-reducing polymer can be included in a well fluid in an amount equal to or less than 0.2% by weight of the water present in the well fluid. Preferably, any friction-reducing polymers are included in a concentration sufficient to reduce friction but at a lower concentration than would develop the characteristic of a gel. By way of example, the well fluid including the friction-reducing polymer would not exhibit an apparent yield point. While the addition of a friction-reducing polymer may minimally increase the viscosity of the treatment fluids, the polymers are not included in the treatment fluids in an amount sufficient to substantially increase the viscosity. For example, if proppant is included in the treatments fluid, velocity rather than fluid viscosity generally may be relied on for proppant transport. In some embodiments, the friction-reducing polymer can be present in an amount in the range of from about 0.01% to about 0.15% by weight of the well fluid. In some embodiments, the friction-reducing polymer can be present in an amount in the range of from about 0.025% to about 0.1% by weight of the well fluid.

Generally, the treatment fluids in slick-water fracturing not relying on viscosity for proppant transport. Where particulates (e.g., proppant, etc.) are included in the fracturing fluids, the fluids rely on at least velocity to transport the particulates to the desired location in the formation. Preferably, a friction-reducing polymer is used in an amount that is sufficient to provide the desired friction reduction without appreciably viscosifying the fluid and usually without a crosslinker. As a result, the fracturing fluids used in these high-rate water-fracturing operations generally have a lower viscosity than conventional fracturing fluids for conventional formations. In some slick-water fracturing embodiments, the treatment fluids may have a viscosity up to about 10 centipoise (“cP”). In some slick-water embodiments, the treatment fluids may have a viscosity in the range of from about 7 cP to about 10 cP.

In an embodiment that includes a fracturing fluid with proppant, the one or more of the fracturing fluids used in the method preferably include in the range of about 1% to about 20% by weight of the proppant. Accordingly, the proppant is in the fracturing fluid at less than about 4 pounds per gallon. More preferably, one or more of the fracturing fluids includes in the range of about 5% to about 10% by weight of the proppant.

For an ultra-low permeable formation, the proppant of a proppant pack formed or to be formed in the fracture complexity preferably has a particulate size range that has an upper end equal to or less than 50 U.S. Standard Mesh. More preferably, the proppant has a graded size range anywhere between −50/+200 U.S. Standard Mesh. Most preferably, the proppant has a graded particle size range anywhere between −70/+140 U.S. Standard Mesh. Typically, the proppant of a proppant pack formed or to be formed in the fracture complexity of an ultra-low permeable formation has a median particle size of about 100 U.S. Standard Mesh.

Hydrajet Fracturing

In some applications, the treatment fluids may be placed in a subterranean formation utilizing a hydrajet tool. The hydrajet tool may be capable of increasing or modifying the velocity or direction of the flow of a fluid into a subterranean formation from the velocity or direction of the flow of that fluid down a well bore. One of the potential advantages of using a hydrajet tool is that a fluid may be introduced adjacent to and localized to specific areas of interest along the well bore without the use of mechanical or chemical barriers. Some examples of suitable hydrajet tools are described in U.S. Pat. Nos. 5,765,642, 5,494,103, and 5,361,856, which are hereby incorporated by reference.

In some embodiments in which a hydrajet tool is used, the fluid(s) introduced through the hydrajet tool are introduced at a pressure sufficient to result in the creation of at least one new fracture in the formation. A hydrajetting tool having at least one fluid jet-forming nozzle is positioned adjacent to a formation to be fractured and fluid is then jetted through the nozzle against the formation at a pressure sufficient to form a cavity and to fracture the formation. Because the jetted fluid must flow out of the slot in a direction generally opposite to the direction of the incoming jetted fluid, it is trapped in the cavity to create a high stagnation pressure at the tip of the cavity. This high stagnation pressure may cause a micro-fracture to be formed that extends a short distance into the formation. That micro-fracture may be further extended by pumping a fluid into the well bore to raise the ambient fluid pressure exerted on the formation while the formation is being hydrajetted. Such a fluid in the well bore will flow into the slot and fracture produced by the fluid jet and, if introduced into the well bore at a sufficient rate and pressure, may be used to extend the fracture an additional distance from the well bore into the formation.

Performing a Fracturing Stage

In general, a fracturing treatment or stage preferably includes pumping the one or more fracturing fluids into a treatment zone at a rate and pressure above the fracture pressure of the treatment zone.

Repeating Fracturing in Another Treatment Zone

A fracturing method can further include repeating the steps of one fracturing stage for another treatment zone.

### Damage to Permeability

In well treatments using viscous well fluids, the material for increasing the viscosity of the fluid can damage the permeability of the proppant pack or the matrix of the subterranean formation. For example, a treatment fluid can include a polymeric material that is deposited in the fracture or within the matrix. By way of another example, the fluid may include surfactants that leave unbroken micelles in the fracture or change the wettability of the formation in the region of the fracture.

The term “damage” as used herein regarding a formation refers to undesirable deposits in a subterranean formation that may reduce its permeability. Scale, skin, gel residue, and hydrates are contemplated by this term. Also contemplated by this term are geological deposits, such as, but not limited to, carbonates located on the pore throats of a sandstone formation.

After application of a filtercake, it may be desirable to restore permeability into the formation. If the formation permeability of the desired producing zone is not restored, production levels from the formation can be significantly lower. Any filtercake or any solid or polymer filtration into the matrix of the zone resulting from a fluid-loss control treatment must be removed to restore the formation's permeability, preferably to at least its original level. This is often referred to as clean up.

Breaker for Viscosity of Fluid or Filtercake

After a treatment fluid is placed where desired in the well and for the desired time, the fluid usually must be removed from the wellbore or the formation. For example, in the case of hydraulic fracturing, the fluid should be removed leaving the proppant in the fracture and without damaging the conductivity of the proppant bed. To accomplish this removal, the viscosity of the treatment fluid must be reduced to a very low viscosity, preferably near the viscosity of water, for optimal removal from the propped fracture.

Reducing the viscosity of a viscosified treatment fluid is referred to as “breaking” the fluid. Chemicals used to reduce the viscosity of treatment fluids are called breakers. Other types of viscosified well fluids also need to be broken for removal from the wellbore or subterranean formation.

No particular mechanism is necessarily implied by the term. For example, a breaker can reduce the molecular weight of a water-soluble polymer by cutting the long polymer chain. As the length of the polymer chain is cut, the viscosity of the fluid is reduced. This process can occur independently of any crosslinking bonds existing between polymer chains.

In the case of a crosslinked viscosity-increasing agent, for example, one way to diminish the viscosity is by breaking the crosslinks. For example, the borate crosslinks in a borate-crosslinked polymer can be broken by lowering the pH of the fluid. At a pH above 8, the borate ion exists and is available to crosslink and cause an increase in viscosity or gelling. At a lower pH, the borate ion reacts with proton and is not available for crosslinking, thus, an increase in viscosity due to borate crosslinking is reversible. In contrast, crosslinks formed by zirconium, titanium, antimony, and aluminum compounds, however, are such crosslinks are considered non-reversible and are broken by other methods than controlling pH.

Thus, removal of the treatment fluid is facilitated by using one or more breakers to reduce fluid viscosity.

Breakers must be selected to meet the needs of each situation. First, it is important to understand the general performance criteria of breakers. In reducing the viscosity of the treatment fluid to a near water-thin state, the breaker must maintain a critical balance. Premature reduction of viscosity during the pumping of a treatment fluid can jeopardize the treatment. Inadequate reduction of fluid viscosity after pumping can also reduce production if the required conductivity is not obtained.

A breaker should be selected based on its performance in the temperature, pH, time, and desired viscosity profile for each specific treatment.

In fracturing, for example, the ideal viscosity versus time profile would be if a fluid maintained 100% viscosity until the fracture closed on proppant and then immediately broke to a thin fluid. Some breaking inherently occurs during the 0.5 to 4 hours required to pump most fracturing treatments. One guideline for selecting an acceptable breaker design is that at least 50% of the fluid viscosity should be maintained at the end of the pumping time. This guideline may be adjusted according to job time, desired fracture length, and required fluid viscosity at reservoir temperature.

Chemical breakers used to reduce viscosity of a well fluid viscosified with a viscosity-increasing agent or to help remove a filtercake formed with such a viscosity-increasing agent are generally grouped into three classes: oxidizers, enzymes, and acids.

For a polymeric viscosity-increasing agent, the breakers operate by cleaving the backbone of polymer by hydrolysis of acetyl group, cleavage of glycosidic bonds, oxidative/reductive cleavage, free radical breakage, or a combination of these processes.

For surfactant gels, there are two principal methods of breaking: dilution with formation fluids and chemical breakers, such as acids.

A breaker may be included in a treatment fluid in a form and concentration at selected to achieve the desired viscosity reduction at a desired time.

Oxidizers commonly used to reduce viscosity of natural polymers includes, for example, sodium persulfate, potassium persulfate, ammonium persulfate, lithium or sodium hypochlorites, chlorites, peroxide sources (sodium perborate, sodium percarbonate, calcium percarbonate, urea-hydrogen peroxide, hydrogen peroxide, etc.), bromates, periodates, permanganates, etc. In these types of breakers, oxidation-reduction chemical reactions occur as the polymer chain is broken.

Different oxidizers are selected based on their performance at different temperature and pH ranges. Consideration is also given to the rate of oxidation at a particular temperature and pH range. For example, the rate at which a persulfate molecule breaks into two radicals is temperature dependent. Below 120° F. (49° C.) this process occurs very slowly.

Enzymes are also used to break the natural polymers in oil field applications. They are generally used at low temperature in the range of 25° C. (77° F.) to 70° C. (158° F.), as at higher temperature they denature and become ineffective. At very low temperatures, enzymes are not as effective as the rate of breakage of polymer is very slow. Different types of enzymes are used to break different types of bond in the polysaccharides. Some enzymes break only α-glycosidic linkage and some break β-glycosidic linkage in polysaccharides. Some enzymes break polymers by hydrolysis and some by oxidative pathways. Generally, Hemicellulase is used to break guar polymers and Xanthanase is used to break Xanthan polymers. A specific enzyme is needed to break a specific polymer/polysaccharide. Enzymes are referred to as “Nature's catalysts” because most biological processes involve an enzyme. Enzymes are large protein molecules, and proteins consist of a chain of building blocks called amino acids. The simplest enzymes may contain fewer than 150 amino acids while typical enzymes have 400 to 500 amino acids.

Acids also provide a break via hydrolysis. Acids, however, pose various difficulties for practical applications.

Step of Introducing Acid-Producing Anaerobic Microorganism into Formation

Extremophiles are organisms that live in “extreme” environments. The name, first used in 1974 in a paper by a scientist named R. D. MacElroy, literally means extreme loving. These hardy creatures are remarkable not only because of the environments in which they live, but also because some types could not survive in supposedly normal, moderate environments.

Many extreme environments, such as acidic or hot springs, saline and/or alkaline lakes, deserts and the ocean beds are also found in nature, which are too harsh for normal life to exist. Any environmental condition that can be perceived as beyond the normal acceptable range is an extreme condition. Varieties of microbes, however, survive and grow in such environments. These organisms, known as extremophiles, not only tolerate specific extreme conditions, but also usually require these for survival and growth. Most extremophiles are found in microbial world. The range of environmental extremes tolerated by microbes is much broader than other life forms. The limits of growth and reproduction of microbes are, from about minus 12° C. (10° F.) to more than 100° C. (212° F.), pH in the range of 0 to 13, hydrostatic pressures up to 1.4×10⁷ kg/m² (1400 atm or 21, psi), and salt concentrations up to saturated brines. T. Satyanarayana, Chandralata Raghukumar, and S. Shivaji, Extremophilic microbes: Diversity and perspectives, Current Science, Vol. 89, No. 1, July 2005, pp. 78-90.

For well treatments, extremophiles can be selected that can live in subterranean formations, for example, up to 100° C. (212° F.) and a pressure up to about 1.4×10⁷ kg/m² (1,400 atmospheres or 21,000 psi).

A “microbe” or “microorganism” is an organism that is microscopic or submicroscopic, which means it is too small to be seen by the unaided human eye. Microorganisms were first observed by Anton van Leeuwenhoek in 1675 using a microscope of his own design. A microbe is a microscopic organism that comprises a single cell (unicellular), cell clusters, or multicellular relatively complex organisms. Microorganisms are very diverse and they include bacteria, fungi, algae, and protozoa. Although microscopic, viruses and prions are not considered microorganisms because they are generally regarded as non-living.

The word “microbial” is derived from microbe. For example, microbial degradation implies degradation by a microbe.

Bacteria are a large domain of prokaryotic microorganisms. Bacteria are typically a few micrometers in length and have a wide range of shapes, ranging from spheres to rods and spirals. Bacteria are present in most habitats on Earth, growing in soil, acidic hot springs, radioactive waste, water, deep in the Earth's crust, as well as in organic matter.

Thermophiles are a type of microorganism that can survive at high temperatures. For example, some thermophile bacteria can live in a temperature range from −12° C. (10° F.) to +100° C. (212° F.). The latest knowledge gathered on these thermophiles reveals that some thermophiles can survive at up to 121° C. (249.8° F.). The thermophile bacteria have a tendency to multiply, approximately 2 fold-3 fold within a few hours to a few days when exposed to a suitable environment (temperature and a nutrition medium).

Barophiles are a type of microorganism that can survive under great pressures. They live deep under the surfaces of the earth or water. There are three kinds of these microorganisms: barotolerant, barophilic, and extreme barophiles. Barotolerant extremophiles can survive at up to 400 atmospheres (4×10⁶ kg/m²) below the water or earth, but grow best in 1 atmosphere (1×10⁴ kg/m²). Barophilic extremophiles grow best at higher pressures in the range of about 500 to 600 atmospheres (5.2×10⁶ to 6.2×10⁶ kg/m²). Extreme barophiles do best at 700 atmosphere (7.2×10⁶ kg/m²) or more, but some survive at 1 atmosphere (1×10⁴ kg/m²).

Microorganisms require a suitable source of nutrition. A sugar, such as molasses, is one nutrient option. Thioglycollate broth is another example. Preparation of bacteria-nutrient mixtures is a well-established commercial process utilizing low cost raw materials, and is widely used in other industries and applications. Hence, the present invention has the potential to be a cost effective and commercially viable technology.

In addition, it is contemplated that a water-soluble polysaccharide can be a source of nutrition for an acid-producing microorganism. The microorganism may be able to use the polysaccharide as a direct source of nutrition. Optionally, subject to temperature stability, an enzyme for the polysaccharide can be included that breaks the polysaccharide into sugar molecules. This can serve a dual purpose of breaking the viscosity of a well fluid that is viscosified with a polysaccharide as well as providing at least some of a nutrition source for the acid-producing microorganism.

Anaerobic respiration is a form of respiration using electron acceptors other than oxygen. Although oxygen is not used as the final electron acceptor, the process still uses a respiratory electron transport chain; it is respiration without oxygen. In order for the electron transport chain to function, an exogenous final electron acceptor must be present to allow electrons to pass through the system. In aerobic organisms, this final electron acceptor is oxygen. Molecular oxygen is a highly oxidizing agent and, therefore, is an excellent acceptor. In anaerobes, other less-oxidizing substances such as sulfate (SO₄²⁻), nitrate (NO₃⁻), or sulfur (S) are used. These terminal electron acceptors have smaller reduction potentials than O₂, meaning that less energy is released per oxidized molecule. Anaerobic respiration is, therefore, in general energetically less efficient than aerobic respiration.

Mixed acid fermentation is an anaerobic fermentation where the products are a complex mixture of acids, particularly lactate, acetate, succinate and formate as well as ethanol and equal amounts of H₂ and CO₂. It is characteristic for members of the Enterobacteriaceae family. M. Madigan & J. Martinko, 11th edition, (2006) Brock's Biology of Microorganisms, NJ, Pearson Prentice Hall, p. 352.

The acid-producing microorganisms typically produce lactic acid, formic acid, acetic acid, propionic acid, etc. The pH that is expected due to acid liberation from the microorganisms is in the range of about 2 to about 4. This is sufficiently acidic to react with calcium or magnesium carbonate so that it can be dissolved.

This acidic pH does not kill the microorganisms as the acid-producing microorganism maintains its internal pH close to neutral and hence maintains a large chemical proton gradient across the cell membrane. However, even with this large chemical proton gradient, the movement of proton inside the cell is minimized by an intra-cellular net positive charge.

Many subterranean formations fall within a temperature and pressure range in which thermophiles and barophiles can live. Some thermophiles and barophiles are acid producing. Hence, the type of bacteria, initial concentration of the microorganism, and the nutrition to be used, can be adjusted depending on the amount of acid desired to be produced in situ in a formation.

Examples of such extremophiles that are expected to be useful microorganisms according to the invention include Enterobacteriaceae, Escherichia coli, Serratia marcescens, Pseudomonas putida, Klebsiella pneumoniae, and any combination thereof. An example of Enterobacteriaceae is Enterobacter Cloacae.

Optional Step of Acidizing with Bronsted-Lowry Acid

Optionally, the use of acid-producing microorganism can be combined with using acid for acidizing of carbonate in a subterranean formation. As discussed above, the microorganism can be tolerant to acidic conditions. Accordingly, it is optional to use both one or more acids to initiate acidizing carbonate in a subterranean formation. The acid-producing microorganism can generate additional acid in-situ, supplementing the effectiveness of the acid treatment.

The pH value represents the acidity of a solution. The potential of hydrogen (pH) is defined as the negative logarithm to the base 10 of the hydrogen concentration, represented as [H⁺] in moles/liter.

Mineral acids tend to dissociate in water more easily than organic acids, to produce H⁺ ions and decrease the pH of the solution. Organic acids tend to dissociate more slowly than mineral acids and less completely.

Relative acid strengths for Bronsted-Lowry acids are expressed by the dissociation constant (pKa). A given acid will give up its proton to the base of an acid with a higher pKa value. The bases of a given acid will deprotonate an acid with a lower pKa value. In case there is more than one acid functionality for a chemical, “pKa(1)” makes it clear that the dissociation constant relates to the first dissociation.

Water (H₂O) is the base of the hydronium ion, H₃O⁺, which has a pKa −1.74. An acid having a pKa less than that of hydronium ion, pKa −1.74, is considered a strong acid.

Optionally, a treatment fluid for use in the methods comprises one or more water-soluble acids having a pKa(1) in water of less than 10 and that are in sufficient concentration such that the water has a pH less than 5. Such a treatment fluid is sometimes referred to herein as an acidizing fluid. More preferably, the acidizing fluid comprises one or more acids having a pKa(1) in water of less than 5. Still more preferably, the one or more acids in the acidizing fluid are in a sufficient concentration such that the water has a pH less than 4. Most preferably, the treatment fluid comprises one or more strong acids such that the pH is less than 2. For example, it is contemplated that the treatment fluid can be up to 7% w/w HCl.

For example, hydrochloric acid (HCl) has pKa −7, which is greater than the pKa of the hydronium ion, pKa −1.74. This means that HCl will give up its protons to water essentially completely to form the H₃O⁺ cation. For this reason, HCl is classified as a strong acid in water. One can assume that all of the HCl in a water solution is 100% dissociated, meaning that both the hydronium ion concentration and the chloride ion concentration correspond directly to the concentration of added HCl.

Optionally, a treatment fluid that is acidic, especially an acidizing fluid, additionally comprises a corrosion inhibitor that does not interfere with the acid-producing microorganism.

Optionally, an acidizing fluid can include a viscosity-increasing agent, and, if additionally helpful, a cross-linking agent. This can help with matrix diversion of the acidizing treatment. The addition of a viscosifying agent can also help retard the acid reactivity.

For example, there are certain VES fluids that develop viscosity after the acid starts to spend and the pH increases. This viscosification is due to the increase in salinity of the system as acid spends on carbonate or dolomite formations releasing either CaCl₂ or a mixture of CaCl₂ and MgCl₂ in the system. With an increase in the salinity, the surfactant molecules rearrange themselves into asymmetric rod-shaped micelles that become entangled with the application of shear and hence the fluid develops high viscosity. The increase in viscosity as the acid spends results in better diversion, which can be considered as another advantage of using a VES fluid. The acid diversion is very important in an acid stimulation treatment to enhance oil production by creating better wormholes. It also increases the depth of penetration of acid into the reservoir.

An example of a VES that develops viscosity as an acid spends is a mixture of 75% (w/w) active surfactant a quaternary ammonium fatty amine, specifically bis(hydroxyethyl)methyloleylammonium chloride (CAS 18448-65-2), in a suitable solvent, preferably 25% propylene glycol (CAS 57-55-6). It is used as a viscoelastic surfactant for acidizing applications (e.g., using HCl). While little viscosity is imparted to the live acid by this VES at low pH, once the acid spends, the viscosity rapidly climbs. Accordingly, acids such as HCl with VES form an effective self-diverting acid system. When used in self-diverting acid systems, VES is commonly used at a concentration of about 4% v/v (40 g/Mgal) to about 6% v/v (60 gal/Mgal).

The propylene glycol with the surfactant is a solvent present in the commercial mixture. It is used as a solvent in the reactions to synthesize the surfactant compounds. It is also useful to maintain this formulation flowable for handling purpose. It can neither act as a surfactant nor as a co-surfactant. It is uncharged species and hence cannot interfere in the formation of aggregation of surfactant molecules, which is basis of building viscosity in a fluid. Propylene glycol is not essential but it may affect the solvent properties of water that can affect aggregation of these surfactant molecules.

### Selecting the Subterranean Formation

The subterranean formation can be selected on the basis of any one or more of at least the following criteria: mineralogy, permeability, API gravity of any present crude or natural gas, static temperature, pressure, and static pressure.

Preferably, the methods are used to treat a subterranean formation that comprises at least 50% by weight (excluding any contained liquid) of one or more alkaline earth carbonates.

Preferably, the methods are used to treat a subterranean formation that has a permeability of less than 1 milliDarcy. More preferably, the subterranean formation has a permeability of less than 0.1 milliDarcy.

Preferably, the methods are used to treat a subterranean formation that is a reservoir for oil having API gravity of at least 22.3 degrees (medium or light oil) or the subterranean formation is a reservoir for natural gas. Preferably, the oil has API gravity of greater than 31.1 degrees (light oil).

Preferably, the methods are used to treat a subterranean formation that has a bottom hole static temperature in the range of 60° C. (140° F.) to 121° C. (250° F.). More preferably, the subterranean formation has a bottom hole static temperature in the range of 60° C. (140° F.) to 100° C. (212° F.).

Preferably, the methods are used to treat a subterranean formation that has a static pressure in the range of 7×10⁴ kg/m² (100 psi) to 1×10⁶ kg/m² (2,200 psi).

For example, in an embodiment the subterranean formation can have the following characteristics: comprise at least 50% of one or more alkaline earth carbonates; have a bottom hole static temperature anywhere in the range of 60° C. to 121° C.; have a permeability of less than 1 milliDarcy; and be a reservoir for oil having API gravity of at least 22.3 degrees or the subterranean formation is a reservoir for natural gas. Preferably, the API gravity greater than 31.1 degrees.

Preferably, the methods include a step of selecting the subterranean formation and the microorganism to be compatible for the survival of the microorganism.

### Well Fluids

In general, the one or more well fluids for use in the steps of the methods according to the invention are preferably water-based.

Preferably, the water for use in a well fluid does not contain anything that would adversely interact with the other components used in the well fluid or with the subterranean formation.

The aqueous phase can include freshwater or non-freshwater. Non-freshwater sources of water can include surface water ranging from brackish water to seawater, brine, returned water (sometimes referred to as flowback water) from the delivery of a well fluid into a well, unused well fluid, and produced water. As used herein, brine refers to water having at least 40,000 mg/L total dissolved solids.

In some embodiments, the aqueous phase of the treatment fluid may comprise a brine. The brine chosen should be compatible with the formation and should have a sufficient density to provide the appropriate degree of well control.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Suitable salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, e.g., the temperature at which the salt precipitates from the brine as the temperature drops.

A well fluid can contain additives that are commonly used in oil field applications, as known to those skilled in the art. These include, but are not necessarily limited to, brines, inorganic water-soluble salts, salt substitutes (such as trimethyl ammonium chloride), pH control additives, surfactants, breakers, breaker aids, oxygen scavengers, alcohols, scale inhibitors, corrosion inhibitors, hydrate inhibitors, fluid-loss control additives, oxidizers, chelating agents, water control agents (such as relative permeability modifiers), consolidating agents, proppant flowback control agents, conductivity enhancing agents, clay stabilizers, sulfide scavengers, fibers, nanoparticles, and combinations thereof.

Of course, additives should be selected for not interfering with the purpose of the well fluid.

Methods of Treating a Well with the Well Fluids

According to another embodiment of the invention, a method of treating a well, is provided, the method including the steps of: forming one or more treatment fluids according to the invention; and introducing the one or more treatment fluids into the well.

Forming a Well Fluid

A well fluid can be prepared at the job site, prepared at a plant or facility prior to use, or certain components of the well fluid can be pre-mixed prior to use and then transported to the job site. Certain components of the well fluid may be provided as a “dry mix” to be combined with fluid or other components prior to or during introducing the well fluid into the well.

In certain embodiments, the preparation of a well fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Introducing Into Well or Zone

Often the step of delivering a well fluid into a well is within a relatively short period after forming the well fluid, e.g., less within 30 minutes to one hour. More preferably, the step of delivering the well fluid is immediately after the step of forming the well fluid, which is “on the fly.”

It should be understood that the step of delivering a well fluid into a well can advantageously include the use of one or more fluid pumps.

Introducing Below or Above Fracture Pressure

In an embodiment, the step of introducing a treatment fluid is at a rate and pressure below the fracture pressure of a treatment zone.

In an embodiment, the step of introducing comprises introducing under conditions for fracturing a treatment zone. For example, the fluid is introduced into the treatment zone at a rate and pressure that are at least sufficient to fracture the zone.

Allowing Time for Acid or Microorganism Treat the Formation

After the step of introducing a well fluid comprising an acid or acid-generating microorganism, the step of shutting in the subterranean form allows time for the growth of the microorganism, for the generation of the acid and for the released acid to attack carbonate in the formation.

A longer time is required for an acid-producing microorganism to produce acid in-situ. For example, it is expected that the acid-producing microorganism, in the presence of sufficient nutrient for fermentation and sufficient electron-acceptor for respiration, will require at least 15 days to produce substantial concentrations of acid in the formation. Preferably, the step of flowing back is within 90 days of the step of introducing the microorganism.

Producing Hydrocarbon from Subterranean Formation

Preferably, after any such well treatment, a step of producing hydrocarbon from the subterranean formation is the desirable objective.

### CONCLUSION

Therefore, the present invention is well adapted to attain the ends and advantages mentioned as well as those that are inherent therein.

The exemplary fluids disclosed herein may directly or indirectly affect one or more components or pieces of equipment associated with the preparation, delivery, recapture, recycling, reuse, or disposal of the disclosed fluids. For example, the disclosed fluids may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary fluids. The disclosed fluids may also directly or indirectly affect any transport or delivery equipment used to convey the fluids to a well site or downhole such as, for example, any transport vessels, conduits, pipelines, trucks, tubulars, or pipes used to fluidically move the fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, or combinations thereof, and the like. The disclosed fluids may also directly or indirectly affect the various downhole equipment and tools that may come into contact with the chemicals/fluids such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

What is claimed is:

1. A method of treating a subterranean formation penetrated by a wellbore of a well, wherein the subterranean formation comprises carbonate, the method comprising the steps of:
(a) fracturing to create at least one fracture in the subterranean formation;
(b) introducing an acid-producing anaerobic microorganism into the fracture; and
(c) introducing nutrition for the microorganism into the fracture.

2. The method according to claim 1, further comprising the step of: introducing an electron acceptor for respiration of the microorganism.

3. The method according to claim 1, wherein the nutrition is selected from the group consisting of: (a) a sugar; (b) a glycolate; (c) a water-soluble polysaccharide; (d) a water-soluble polysaccharide with an enzymatic breaker for the polysaccharide; and (e) any combination of the foregoing.

4. The method according to claim 1, further comprising the step of: after the step of introducing the microorganism, flushing the wellbore to the subterranean formation to wash the microorganism from the wellbore and into the subterranean formation.

5. The method according to claim 1, further comprising the step of: after the steps of introducing the microorganism and the nutrition, shutting in the subterranean formation with the microorganism.

6. The method according to claim 5, further comprising the step of: after the step of shutting in, the step of flowing back a fluid from the subterranean formation to the wellbore.

7. The method according to claim 1, wherein the step of introducing the microorganism is prior to a step of flowing back from the subterranean formation any downhole fluid resulting from the fracturing fluid.

8. The method according to claim 1, wherein the step of introducing the microorganism is within 3 months of the step of fracturing.

9. The method according to claim 1, wherein the step of introducing the microorganism is simultaneous with the step of fracturing.

10. The method according to claim 1, wherein the step of introducing the microorganism and the step of introducing the nutrition are simultaneous.

11. The method according to claim 1, wherein the microorganism is an extremophile wherein the microorganism is capable of living at a temperature above 60° C.

12. The method according to claim 11, wherein the microorganism is selected from the group consisting of: Enterobacteriaceae, Escherichia Coli, Serratia marcescens, Pseudomonas putida, and Klebsiella pneumoniae, and any combination thereof.

13. The method according to claim 1, wherein the subterranean formation comprises at least 50% of one or more alkaline earth carbonates.

14. The method according to claim 1, wherein the subterranean formation has a bottom hole static temperature in the range of 60° C. to 121° C.

15. The method according to claim 1, wherein the subterranean formation has a permeability of less than 1 milliDarcy.

16. The method according to claim 1, wherein the subterranean formation is a reservoir for oil having API gravity of at least 22.3 degrees or the subterranean formation is a reservoir for natural gas.

17. A method of treating a subterranean formation penetrated by a wellbore of a well, wherein the subterranean formation comprises carbonate, the method comprising the steps of:
(a) introducing a fracturing fluid at a sufficiently high flow rate and pressure into the wellbore and into the subterranean formation to create or enhance one or more fractures in the subterranean formation;
(b) introducing a treatment fluid comprising an acid-producing anaerobic microorganism into the fracture; and
(c) introducing a treatment fluid comprising nutrition for the microorganism into the fracture.

18. The method according to claim 17, further comprising the step of: introducing a treatment fluid comprising an electron acceptor for respiration of the microorganism.

19. The method according to claim 17, wherein the step of introducing the treatment fluid comprising the microorganism and the step of introducing the treatment fluid comprising the nutrition are simultaneous, wherein the treatment fluids are the same.

20. The method according to claim 17, further comprising the step of: after the steps of introducing the microorganism and the nutrition, shutting in the subterranean formation.

21. The method according to claim 17, wherein the microorganism is an extremophile wherein the microorganism is capable of living at a temperature above 60° C.

22. The method according to claim 21, wherein the microorganism is selected from the group consisting of: Enterobacteriaceae, Escherichia Coli, Serratia marcescens, Pseudomonas putida, and Klebsiella pneumoniae, and any combination thereof.

23. The method according to claim 17, wherein the subterranean formation has a permeability of less than 1 milliDarcy.
